(19) United States
(12) Patent Application Publication
(10) Pub. No.: US 2013/0094486 A1
(43) Pub. Date: Apr. 18, 2013

(54) Wireless Network Virtualization For Wireless Local Area Networks

(71) Applicants: Gautam BHANAGE, Sunnyvale, CA (US); Dipti VETE, Edison, NJ (US); Ivan SESKAR, Princeton, NJ (US); Dipankar RAYCHAUDHURI, Princeton Junction, NJ (US)

(72) Inventors: Gautam BHANAGE, Sunnyvale, CA (US); Dipti VETE, Edison, NJ (US); Ivan SESKAR, Princeton, NJ (US); Dipankar RAYCHAUDHURI, Princeton Junction, NJ (US)

(73) Assignee: RUTGERS, THE STATE UNIVERSITY OF NEW JERSEY, New Brunswick, NJ (US)

(21) Appl. No.: 13/600,912

(22) Filed: Aug. 31, 2012

Related U.S. Application Data
(60) Provisional application No. 61/530,524, filed on Sep. 2, 2011.

(51) Int. Cl. H04W 88/08

(52) U.S. Cl. CPC H04W 88/08
USPC 370/338

(57) ABSTRACT

An access point of a wireless network including: a controller for emulating a first virtual access point of a first service provider and a second virtual access point of second service provider; a transceiver port for communicating control signals to clients of the first and service providers to limit the uplink air-time of the clients; and a connection port for linking the first and second service providers to a backhaul.

This invention claims the benefit of Provisional Patent Application No. 61/530,524 filed on Sep. 2, 2011, which is hereby incorporated by reference in its entirety.

The government has rights in this invention pursuant to Grant #CNS-072505 awarded by the U.S. National Science Foundation.

### BACKGROUND OF THE INVENTION

1. Field of the Invention

The embodiments of the invention relate to a providing air-time to a group of clients sharing an access point, and more particularly, to providing air-time guarantees for each of a group of clients sharing an access point. Although embodiments of the invention are suitable for a wide scope of applications, it is particularly suitable for providing uplink air-time guarantees for each client of groups of different virtual network providers sharing an access point.

2. Discussion of the Related Art

In general, the advent of pervasive wireless systems in the form of inexpensive handheld devices is expected to lead to an ever increasing deployment of wireless hotspots. More and more internet service providers (ISPs) are aiming to provide wireless internet services via a wireless infrastructure provider at locations such as airports, cafes and common shopping areas. Accordingly, two or more ISPs may share the same wireless infrastructure at a given location. However, the quality of service is a substantial challenge to the internet service providers (ISPs) trying to provide an access point (AP) on the wireless local area network (WLAN) of the shared wireless infrastructure. A system is desired to ensure that the AP sharing will work across a wide range of client hardware, while providing each user group, e.g. clients belonging to a single ISP, with aggregate air-time commensurate to the revenue contract of the ISP with the wireless infrastructure provider. Apart from providing baseline fairness in air-time across groups, other requirements for sharing WLAN access point hardware across different ISPs include: different broadcast domains, different levels of security, support different protocols above a basic connection, ease of deployment, and minimum bandwidth loss for resource partitioning.

Among prior art AP based infrastructures, the DenseAP architecture is a mechanism for sharing air-time by managing handoffs across APs. Another architecture for Worldwide Interoperability for Microwave Access (WiMAX) radios shares download (DL) air-time. An architecture for supporting a virtualized client connection to multiple networks from a single wireless client has also been studied. However, none of the prior art AP based infrastructures specifically deal with the problem of providing an architecture for sharing upload air-time to a single AP of a WLAN across multiple user groups.

In the domain of air-time fairness architectures, enhanced distributed channel access (EDCA) parameters, such as contention windows (CW) and transmission opportunities (TxOp), have been used for controlling air-time usage across clients. For example, EDCA parameters are used to determine fairness across competing UL stations with TCP traffic use. In another example, a proportional fair allocation is based on 802.11e EDCA parameters in that equal share of channel time is given to high and low bit rate stations such that high bit rate stations can obtain more throughput.

In another air-time fairness architecture, a time fair carrier sense multiple access (CSMA) protocol controls minimum contention window size to achieve estimated target uplink throughput for each competing station in multirate WLAN. Other possible control mechanisms for air-time fairness can include one using adaptive interframe space (AIFS) and the other using contention window size. A prior art time based regulator air-time fairness architecture has also been proposed that achieves uplink air-time fairness by ensuring equal “long term” channel occupancy time for every node in a WLAN. In yet another air-time fairness architecture, information on current channel quality to the respective station associated with the AP is used to schedule downlink transmission to that particular station by limiting frame transmission rate. None of the prior art architectures address the problem of enforcing UL air-time fairness across multiple user groups of an AP.

### SUMMARY OF THE INVENTION

Accordingly, embodiments of the invention is directed to wireless network virtualization for wireless local area networks that substantially obviates one or more of the problems due to limitations and disadvantages of the related art.

An object of embodiments of the invention is to provide sharing of UL air-time within a group of users to be fair and equal.

Another object of embodiments of the invention is to facilitate sharing of the sum of downlink and uplink airtime within a group of users.

Another object of embodiments of the invention is to work with a large number of clients without significant control overheads that interfere with throughput.

Another object of embodiments of the invention is to be able to adapt to changing environment conditions due to the network load, protocol type, the channel conditions for individual clients and dynamic addition or removal of wireless clients.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, an access point of a wireless network includes: includes: a controller for emulating a first virtual access point of a first service provider and a second virtual access point of second service provider; a transceiver port for communicating control signals to clients of the first and service providers to limit the uplink air-time of the clients; and a connection port for linking the first and second service providers to a backhaul.

In another aspect, an access point of a wireless network includes: a controller for maintaining a first uplink air-time to the first service provider and a second uplink air-time to the second service provider; a transceiver port for emitting a first control signal to limit a first client of the first service provider to a first portion of first uplink air-time and a second control signal to limit a second client of the second service provider to a second portion of second uplink air-time; and a connection port for linking the first and second service providers to a backhaul.

In another aspect, an access point of a wireless network includes: a controller for calculating a first portion of a first uplink air-time for a first client of a first service provider and a second portion of a second uplink air-time for a second client of a second service provider; a transceiver port for emitting a first control signal to limit the first client of the first service provider to a first portion of first uplink air-time and a second control signal to limit the second client of the second service provider to a second portion of second uplink air-time; and a connection port for linking the first and second service providers to a backhaul.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 illustrates a diagram of a single wireless access point emulating multiple virtual access points for clients from different internet service providers according to an embodiment of the invention.

FIG. 2 is a diagram showing the functionalities of a single wireless access point emulating multiple virtual access points and of a client according to an embodiment of the invention.

FIG. 3 is client software stack in the SplitAP architecture according to an embodiment of the invention.

FIG. 4 is a click modular router datapath for implementing the shaping at the client according to an embodiment of the invention.

FIG. 5 is a design of a proportional controller at the AP according to an embodiment of the invention.

FIG. 6 is a comparison for UL air-time group fairness.

FIG. 7 is a comparison for UL air-time group throughput.

### DETAILED DESCRIPTION OF THE PREFERRED EMBODIMENTS

Reference will now be made in detail to the preferred embodiments of the invention, examples of which are illustrated in the accompanying drawings. Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements.

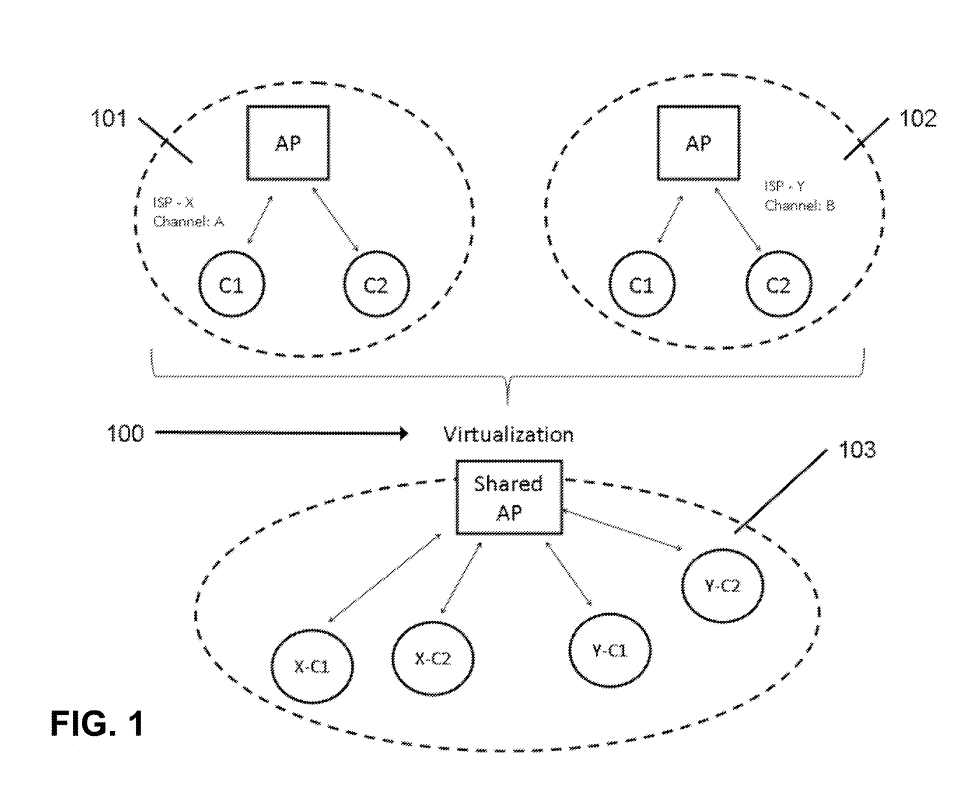

Embodiments of the invention have a split access point (SplitAP) architecture that employs wireless network virtualization. FIG. 1 illustrates a diagram of a single wireless access point emulating multiple virtual access points for clients from different internet service providers according to an embodiment of the invention. As shown in the diagram 100 of FIG. 1, the AP 101 of an ISP-X and the AP 102 of an ISP-Y can be combined into a shared AP 103 for both ISP-X and ISP-Y using the SplitAP architecture in accordance with embodiments of the invention.

The SplitAP architecture enables seamless sharing of a particular resource by having the features of abstraction, programmability and isolation, as shown in FIG. 1. Abstraction allows the users of the system to use SplitAP architecture with minimal changes to the client hardware or software. As shown in FIG. 1, virtual access points supported by most commodity AP hardware emulate the functionality of two different physical APs (ISP-X, ISP-Y) with a single physical AP, thus allowing use of the client MAC protocols and hardware unchanged. Programmability is in the setup to allowing a person deploying the hardware to allocate different UL air-time quotas for each of the ISPs at the shared access points. Isolation across groups of wireless users of the ISPs is provided through air-time control at the clients based on the information provided by the SplitAP controller running at the AP. Because a spate of recent applications, such as peer-to-peer file sharing supported by web 2.0 and video conferencing have resulted in significantly increased uplink air-time usage, the problem of uplink air-time control across each of the virtual networks formed by wireless user groups of different ISPs should be addressed.

The use of the phrase slice refers to the resources allocated to that group of users belonging to a single ISP. Different groups of users can have different slices. For example, the slices can each have different bandwidth allocations. The terms groups or slices will now be used interchangeably in further discussion. SplitAP will enforce fairness in UL air-time usage across slices, thus allowing individual ISPs to appropriately share the underlying WLAN hardware and the corresponding channel. Consider a set of M client groups (slices) with each group Sᵢ having Nᵢ clients. Let the fraction of UL air time allocated for every slice Sᵢ∈ M, be denoted by Wᵢ. Wᵢ for each slice is decided during the time of deployment of the infrastructure and can be dependent on a wide range of criterion like pricing, importance of the group and so on. If φⁱⱼ denotes the measured UL air time consumed by the client j∈ Sᵢ slice, the fraction of UL air-time used by every client associated with the access point is calculated as Cⱼⁱ shown in Eq. 1 as follows:

$${C}_{j}^{i} = \frac{{φ}_{j}^{i}}{{\sum }_{p = 1}^{M} {\sum }_{q = 1}^{{N}_{i}} {φ}_{q}^{p}} \qquad Eq . 1$$

The condition of group fairness requires that, the total measured UL air-time for all clients within a slice Sᵢ is limited to Wᵢ shown in Eq. 2 as follows:

$$∀ \{ i ∈ M \} , {\sum }_{j = 1}^{{N}_{i}} {C}_{j}^{i} \leq {W}_{i} \qquad Eq . 2$$

The above condition should be fulfilled while placing no limitation on the individual values of Cⱼⁱ i.e all nodes within a single slice S, should be able to share the UL air-time fairly, independent of the usage on other slices. Hence, in the worst case every client should be able to utilize UL air-time 0≦Cⱼⁱ≦Wᵢ as long as the Eq. 2 is not violated and all clients within Sᵢ share the available UL air-time fairly. Hence, to allow deployment of algorithms to realize such a group air-time fairness mechanism, the SplitAP infrastructure of embodiments of the invention will provide control and measurement features while being transparent to the users of the system.

The SplitAP architecture will have abstraction in that it will employ and extend the functionality of virtual access points which are available as a standard feature on commercial access points for emulating multiple virtual access points on a single physical access point while operating on the same wireless channel. Using this feature the physical AP will be able to broadcast beacons for independent virtual networks of respective ISPs. Hence, clients belonging to different ISP slices can see the ESSID of its ISP and associate with the ESSID, thereby making client side connectivity transparent and simple.

The SplitAP architecture has programmability in that each of the ISPs should have independent control of settings in their network. Different features for each WLANs of the ISPs, such as different security policies, broadcast domains, and IP settings can be individually controlled using virtual access points for each ISP. In addition, independent control of MAC settings, such as aggregation and 802.11e based WMM parameters can be individually controlled using virtual access points for each ISP.

The SplitAP architecture will have isolation across the virtual networks. This can be done through a strict Time division multiple access (TDMA) like scheduler across the virtual networks. However, such a scheduler would require a large change in the medium access control (MAC) mechanism of the clients, thus making them completely incompatible with other 802.11 based commercial access points. The SplitAP can be an incremental design to the existing 802.11 framework and exists as a stand alone entity outside of the driver.

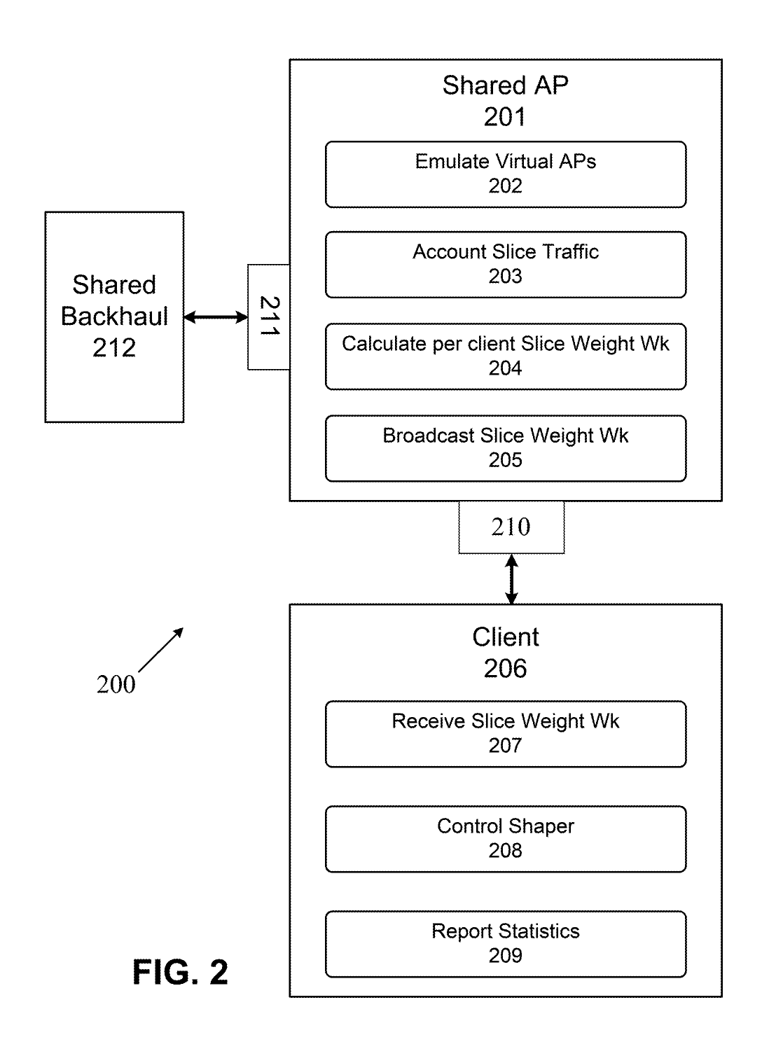

FIG. 2 is a diagram showing the functionalities of a single wireless access point emulating multiple virtual access points and of a client according to an embodiment of the invention. As shown in the diagram 200 of FIG. 2, the shared AP 201 is responsible for emulating the virtual access points 202, accounting of traffic for each of the slices 203, and calculating the weights of UL air-time for each slice 204. Then, the shared AP 201 has a transceiver port 210 to wirelessly transmit the weights of UL air-time 205 to the clients of each slice and for receiving reported statistics from clients for use in the accounting of traffic for each of the slices 203.

The client 206 is responsible for enforcing the commands broadcasted by the controller and reporting statistics of usage. Thus, the client 206 receives the weights of UL air-time 207, controls the shaper of UL bandwidth in the client 208, and reports statistics 209 like the physical layer rate and the average packet size reported by the client interface. The shared AP 201 has a connection port 211 connected to a backhaul for linking all of the client groups on the share AP 201 to a shared backhaul 212.

The shared AP runs a multi-threaded ruby controller that performs the actions described in Algorithm 1 according to an embodiment as follows.

$$\begin{matrix}\begin{matrix}\begin{matrix}{W}_{0 … M} = init slice weights ( ) \\ while True do\end{matrix} \\ \vert \begin{matrix}\begin{matrix}foreach sliceID = getNextSlice ( ) do \\ \vert \begin{matrix}\begin{matrix}\begin{matrix}\begin{matrix}\begin{matrix}\begin{matrix}\begin{matrix}time [ sliceID ] = 0 \\ foreach clientID = getNextClient ( sliceID ) do\end{matrix} \\ \vert \begin{matrix}\begin{matrix}\begin{matrix}\begin{matrix}rate = getPhyRate ( clientID ) \\ bytes = getDataVol ( clientID )\end{matrix} \\ {cl}_{time} = \frac{bytes \times 6}{‘ rate ’}\end{matrix} \\ time [ sliceID ] \div = cl time\end{matrix} \\ \end{matrix}\end{matrix} \\ end\end{matrix} \\ δ = time [ sliceID ] - {W}_{sliceID}\end{matrix} \\ if ( abs ( δ ) > Θ ) then\end{matrix} \\ \vert \begin{matrix}\begin{matrix}{C}_{sliceID} = getWt ( sliceID , slice wt , δ ) \\ broadcast ( sliceID , {C}_{sliceID} )\end{matrix} \\ \end{matrix}\end{matrix} \\ end\end{matrix}\end{matrix} \\ end\end{matrix}\end{matrix} \\ end\end{matrix} \qquad Algorithm 1$$

In the controller, sliceID is a unique identifier used for identifying independent slices owned by different ISPs. The algorithm computes a slice UL air-time usage time[sliceID] for every sliceID, by iterating and determining the UL air-time usage reported by individual clients within every slice, that is a sliceID. Based on this estimate, the algorithm determines the offset of the actual slice utilization from the allocated UL air-time fraction. If this offset is greater than a threshold (Θ), the AP controller broadcasts C_{sliceID} the maximum UL air-time fraction that can be consumed by any individual client within the slice sliceID. A UDP broadcast is used for sending C_{sliceID} to clients to limit control traffic, since the number of control messages are dependent on the number of slices rather than number of clients. C_{sliceID} can be included in the beacons of individual virtual access points to eliminate the need for a separate signaling mechanism. This could be done by using the vendor specific information element (IE) in the beacon transmission to transmit C_{sliceID}. The value of C_{sliceID} can be chosen to be inversely proportional to the UL air-time utilization for that slice. This fraction of channel time is calculated based on the previously broadcasted value and the corresponding slice utilization.

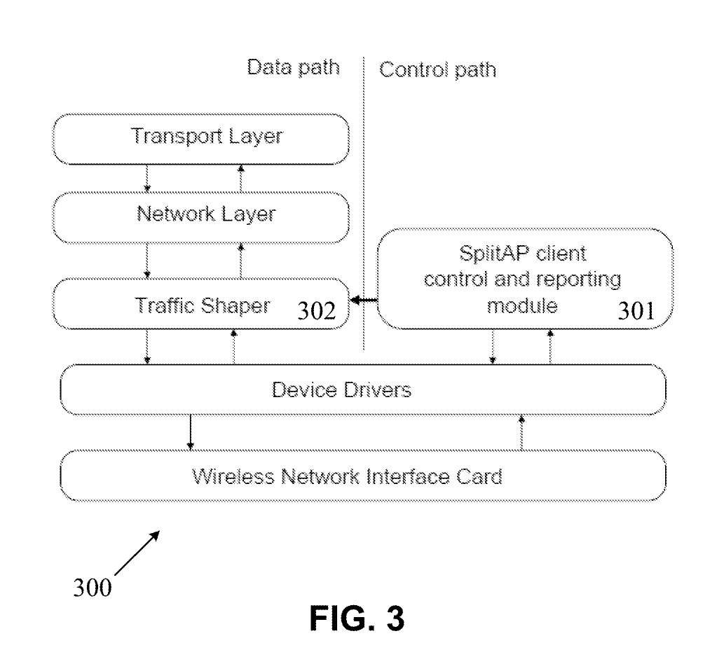

In embodiments of the invention, a SplitAP client control and reporting module application is installed on the client that allows the user to connect to a SplitAP based wireless service provider. The SplitAP client control and reporting module application could be implemented as a web browser plugin that controls client's UL traffic based on commands from the controller. FIG. 3 is client software stack in the SplitAP architecture according to an embodiment of the invention. As shown in FIG. 3, the client software stack 300 has a client control and reporting module 301 for (1) Determining and reporting client side parameters such as physical layer rate (through access of the rate table maintained in the driver), and average packet sizes by querying the proc filesystem or using the driver statistics and (2) Converting the maximum air-time limit enforced by the SplitAP controller to a rate value, and accordingly controlling the shaping module 302 to rate limit the UP of the client. The shaping module 302 is implemented by using a modular router that transparently controls outbound traffic from the interface.

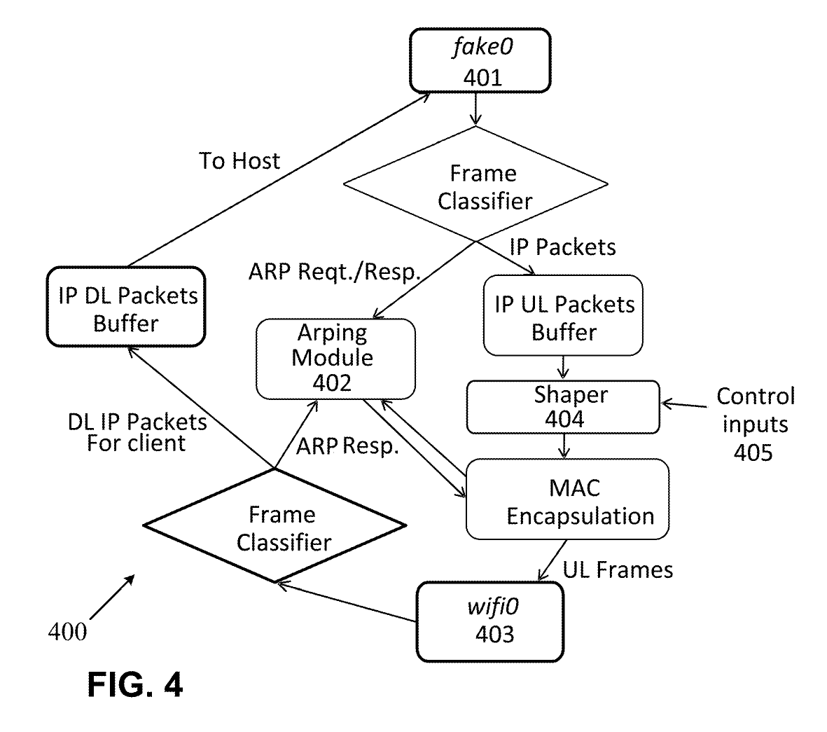

FIG. 4 is a click modular router datapath for implementing the shaping at the client according to an embodiment of the invention. As shown in the click datapath 400 of FIG. 4, all uplink traffic at clients is pulled through a fake0 device 401 created in the kernel. This is done by ensuring that this device registers with the default outbound route for all packets from the client which are to be sent over the wireless network. Address resolution protocol (ARP) is a mechanism by which the network stack or a machine is able to convert an internet protocol (IP) address into a medium access control (MAC) address. ARP 402 is implemented within the click script, and all uplink IP traffic received by the fake0 device 401 is appropriately appended with appropriate MAC headers before being sent to the wifi0 physical interface 403. The traffic shaping is implemented within the click script by the module 404 marked as the shaper. This module 404 receives input 405 from a control program on the client side by listening on a defined TCP socket number. The control input 405 from our client side controller is the rate at which all outbound traffic is to be shaped. The exact rate at which all outbound traffic is shaped is calculated as a deterministic.

The SplitAP architecture can employ different methodologies on the AP for controlling uplink air-time across slices. There are at least two methodologies for calculating C_{sliceID} based on current UL air-time utilization numbers and/or the number of associated clients. Each of the algorithms discussed in this section are ways to implement the getWt( ) function discussed in Algorithm (1) and provide the value C_{sliceID}, which is the maximum air-time that can be consumed by any client in the slice, that is the sliceID.

A linear proportional feedback control (LPFC) based methodology uses a dynamic estimate of the number of clients associated with the AP to calculate the C_{sliceID}. Information on the number of clients associated with the AP is available in the SplitAP controller through querying of the proc interface on the AP. The algorithm calculates C_{sliceID} by determining current number of clients in the slice S_{sliceID} and proportionally splitting the available quota of air time W_{sliceID} among the number of clients N_{sliceID} within the slice To limit the total air-time used by a slice in terms of both uplink and downlink air-time, the W_{sliceID} should be initialized as a difference of the total airtime quota (W_{sliceID}) for that slice and the air-time already used in downlink transmissions. The SplitAP architecture allows this corrected C_{sliceID} to be broadcasted every one second or at another interval desired by the ISP using the slice. If this update is included as a part of the beacon, the broadcast can be sent out every 100 msecs. However, the client may decide to act only on every nth beacon received from the AP.

Instead of generating and broadcasting the C_{sliceID} purely based on the slice UL air-time quota and number of clients in the slice, the LPFC+ methodology of algorithm 2 relies

Algorithm 2

Input: {sliceID, C_{sliceID} ^{prev}, δ}
Output: {C_{sliceID}}
# Estimate clients At Saturation
N_{slice}^{sat} = getSatEstimate (sliceID)
# Calculate per client deficit/surplus
γ = abs(δ ÷ N_{slice}^{sat})
if δ > 0 then
| # If excess, decrease previous guess
| C_{sliceID} = C_{sliceID} ^{prev} − γ
| else
| # If less, increase previous guess
| C_{sliceID} = C_{sliceID} ^{prev} + γ
end
# Update C_{sliceID} ^{prev} for future use.
C_{sliceID} ^{prev} = C_{sliceID}
return C_{sliceID}

on monitoring the current UL air-time utilization for the slice, which is available through the SplitAP client reports and appropriately controlling C_{sliceID}. The algorithm selects C_{sliceID} in such a way that even if the offered load by clients in a slice is not the same, it allows the clients to increase traffic, by increasing C_{sliceID} until the UL air-time quota for the slice is reached. If the quota is exceeded (or under-utilized), the LPFC+ controller proportionally reduces (or increases) C_{sliceID}, the maximum air-time that can be used by any client in the Slice sliceID. As with the LPFC algorithm, the C_{sliceID} can be broadcasted every one second or at any other value desired by the ISP owning the slice.

The difference δ between the current slice UL air-time usage and the slice quota is available as an input since it is already available in the Algorithm (1). Hence γ, the value by which the controller needs to modify the broadcasted CsliceID is directly proportional to δ, but needs to be scaled by the number of clients that will be affected. It is important to scale δ by the number of clients being traffic shaped and not by the number of clients in the slice itself, since the difference in usage of UL slice air-time will only be because of the clients that are currently traffic limited. To determine the number of clients being currently traffic limited, the feedback of change in previous slice air-time for different broadcasted CsliceID is used. Since the CsliceID is currently broadcasted every one second², the change in air-time usage achieved in the previous cycle is used for the broadcasted CsliceID to determine the number of clients being traffic limited as:

$$\begin{matrix}{Q}_{sliceID} = {\sum }_{j = 1}^{{N}_{sliceID}} {C}_{j}^{n} & Eq . 3 \\ {N}_{slice}^{nod} = \frac{Δ ( {Q}_{sliceID} )}{Δ {C}_{sliceID}} & Eq . 4\end{matrix}$$

The getSatEstimate(sliceID) function in Algorithm (2) uses this approach to determine the number of clients being traffic limited within the slice, and finally determines the γ by scaling the δ value with this estimate.

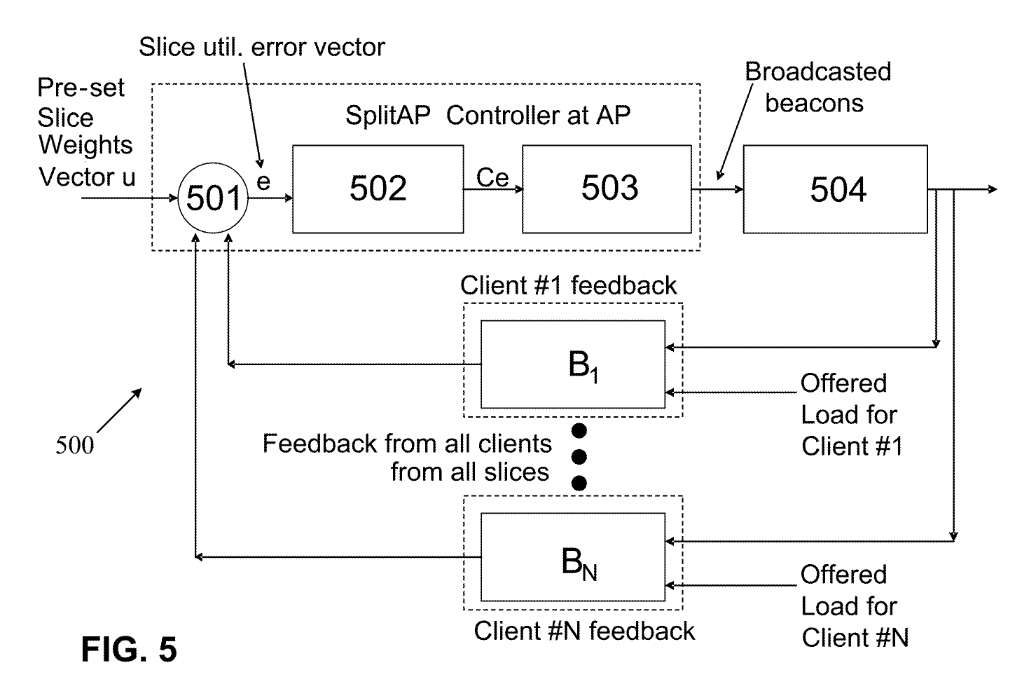

The SplitAP controller design, along with the LPFC+ algorithm forms a proportional controller based feedback system. FIG. 5 is a design of a proportional controller at the AP according to an embodiment of the invention. The set point in a proportional controller of the system 500 is given by the vector u. In this vector, individual values indicate fraction of air-times allocated to every slice. The e is the error vector which signifies the difference in measured air-time per slice and the preset vector u generated by the differentiator 501. The block 502 denotes the compensator, which scales the per slice error appropriately. The per slice error in air-time is scaled by the number of clients ending traffic at the uplink limit. Hence, the block 502 is implemented as,

$$C = \frac{1}{{N}_{slice}^{sat}} , \\ where {N}_{slice}^{sat} \qquad Eq . 5$$

is a vector of the number of clients per slice reaching saturation. The output of the compensator block 502 is given as follows:

$$C \times e = \frac{e}{{N}_{slice}^{sat}} \qquad Eq . 6$$

This input is fed to the actuator 503, which acts on the broadcast plant 504 to produce the appropriate output. The output of the actuator 503 can be broadcast beacons indicating appropriate values of CsliceID, which denotes the maximum UL air-time fraction that can be consumed by any individual client within the slice sliceID. The actuator 503 itself is implemented as:

$$A ( ce , δ ) = \{ \begin{matrix}A = A - ce & if δ > 0 \\ A = A + ce & otherwise\end{matrix} \qquad Eq . 7$$

Otherwise, the vector A is defined as the vector form of CsliceID for the values across slices. Once the CsliceID is propagated to the clients in the plant P, their air-time is appropriately controlled. Finally, feedback in the system is implemented from each of the clients B₁ through B_{N}. Each of these feedback blocks B, return to the AP, the current packet size, offered load, and traffic vectors using which the error vector e is calculated in the AP.

Preliminary evaluations have been made using a small number of clients based on a comparison of UL air-time allocated to individual slice. The evaluations use a modified Jain fairness index for determining weighted UL air-time fairness across flows and flow groups. Let the sum of fraction of channel time used by all clients in slice k be denoted as Ck. Then,

$$I = \frac{{( {\sum }_{k = 1}^{N} {C}_{k} )}^{2}}{N \times {\sum }_{k = 1}^{N} {C}_{k}^{2}} \qquad Eq . 8$$

The fairness index (I) determines the global variation in channel utilization across slices. The air-time is scaled by slice quotas to evaluate fairness under saturation with different slice weights, while also accounting for performance deterioration due to bad channel quality. The fairness index (I) determines the global variation in channel utilization across slices. The air-time is scaled by slice quotas to evaluate fairness under saturation with different slice weights, while also accounting for performance deterioration due to bad channel quality.

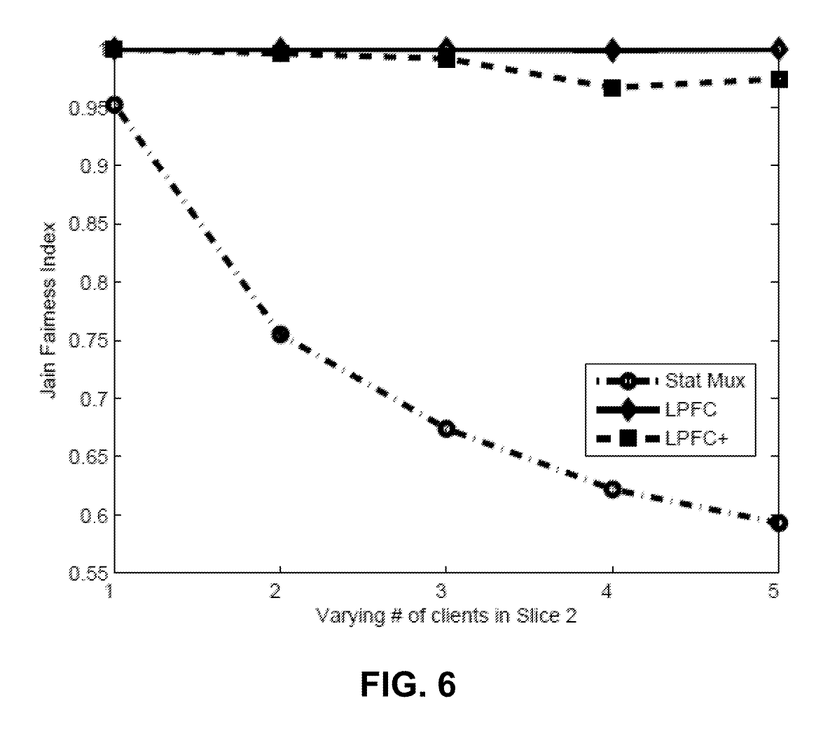

In considering a setup with two slices, the first slice has a single client pumping UDP UL traffic at saturation, while a second slice 2 has 5 clients associated with it. For different experiments, varying number of clients 1-5 on Slice 2 will send saturation UL traffic along with the client on Slice 1. FIG. 6 is a comparison for UL air-time group fairness. The performance of both LPFC and LPFC+ algorithms, as compared to that without our SplitAP setup (Vanilla) are considered. The group fairness index I is always greater than 0.97 with the use of our infrastructure, while it falls down up to 0.6 in a vanilla system without our setup.

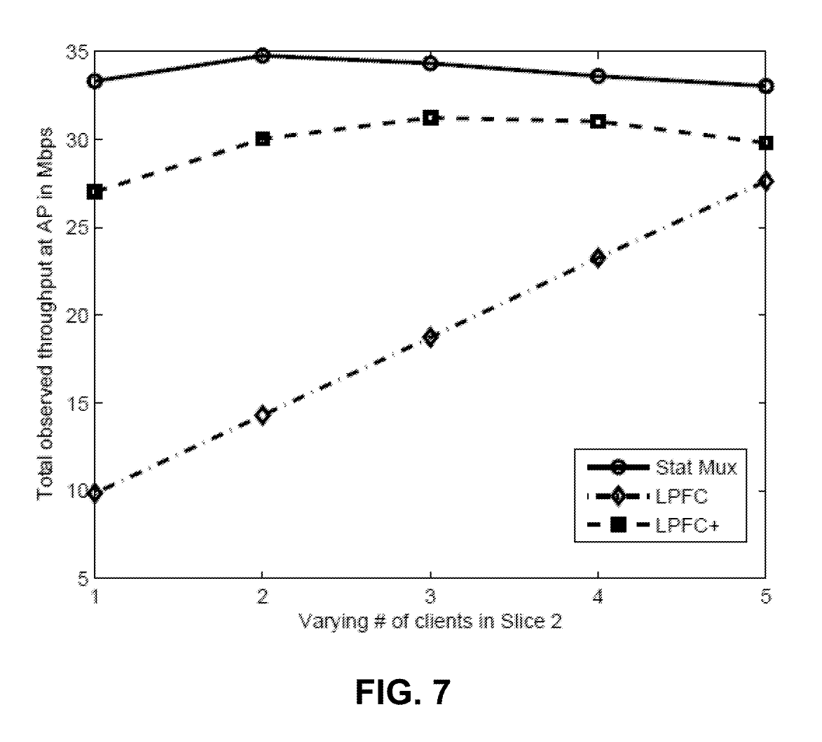

FIG. 7 is a comparison for UL air-time group throughput. As shown in FIG. 7, the throughput measurements show that the improvements in fairness are at the cost of a small decrease in net throughput with the LPFC+ algorithm. The throughput performance with the LPFC algorithm is less when fewer number of clients on Slice 2 send traffic. This is because it sees 5 clients associated with the slice from the beginning, and presents a conservative estimate of CsliceID which results in lower throughput. The LPFC+ algorithm on the other hand dynamically measures air-time for every slice and adapts its CsliceID resulting in better performance. Avoidance of reaching channel capacity for UP air-time can be avoided by keeping a minimum reserve tolerance of 5% to 15% while dividing the remaining UP air-time fairly amongst the ISPs on the channel.

The SplitAP architecture allows a wireless network provider to deploy a shared physical access point, which is capable of running algorithms that control UL air-time across user groups. The proposed architecture can be implemented using different algorithms, such as LPFC and LPFC+. A significant improvement in group air-time fairness results with marginal degradation in overall system throughput. Other algorithms can be deployed on the SplitAP framework, such as an algorithm that takes into account retries at the MAC layer for better estimation of slice quotas.

It will be apparent to those skilled in the art that various modifications and variations can be made in the wireless network virtualization for wireless local area networks of embodiments of the invention without departing from the spirit or scope of the invention. Thus, it is intended that embodiments of the invention cover the modifications and variations of this invention provided they come within the scope of the appended claims and their equivalents.

What is claimed is:

1. An access point of a wireless network, comprising:
a controller for emulating a first virtual access point of a first service provider and a second virtual access point of second service provider;
a transceiver port for communicating control signals to clients of the first and service providers to limit the uplink air-time of the clients; and
a connection port for linking the first and second service providers to a backhaul.

2. The access point of a wireless network according to claim 1, wherein the controller maintains a first uplink air-time to the first service provider that is a difference of total airtime quota for the first service provider and downlink air-time allocated to the first service provider.

3. The access point of a wireless network according to claim 2, wherein the first and second uplink air-times are different.

4. The access point of a wireless network according to claim 2, wherein the controller maintains first and second uplink air-times such that summation of the first and second uplink air-times are less than available uplink air-time bandwidth of the backhaul.

5. The access point of a wireless network according to claim 2, wherein the transceiver port emits a first control signal to limit a first client of the first service provider to a first portion of first uplink air-time and a second control signal to limit a second client of the second service provider to a second portion of second uplink air-time.

6. The access point of a wireless network according to claim 5, wherein the first portion of first uplink air time and the second portion of second uplink air-time are different.

7. The access point of a wireless network according to claim 5, wherein a first client of the first service provider and other clients of the first service provider all receive a same first control signal and each have a same first portion of first uplink air-time.

8. The access point of a wireless network according to claim 5, wherein a second client of the second service provider has a second portion of second uplink air-time larger than a third portion of second uplink air-time for each of the other clients of the second service provider.

9. The access point of a wireless network according to claim 2, wherein the controller accounts uplink air-time for both the first service provider and the second service provider based on reported statistics received from the clients.

10. The access point of a wireless network according to claim 9, wherein the controller calculates a first portion of first uplink air-time for each of a first group of clients of the first service provider and a second portion of second uplink air-time for each of a second group of clients of the second service provider.

11. An access point of a wireless network, comprising:
a controller for maintaining a first uplink air-time to the first service provider and a second uplink air-time to the second service provider;
a transceiver port for emitting a first control signal to limit a first client of the first service provider to a first portion of first uplink air-time and a second control signal to limit a second client of the second service provider to a second portion of second uplink air-time; and
a connection port for linking the first and second service providers to a backhaul.

12. The access point of a wireless network according to claim 11, wherein a first client of the first service provider and other clients of the first service provider all receive a same first control signal and each have a same first portion of first uplink air-time.

13. The access point of a wireless network according to claim 11, wherein a second client of the second service provider has a second portion of second uplink air-time larger than a third portion of second uplink air-time for each of the other clients of the second service provider.

14. The access point of a wireless network according to claim 11, wherein the controller accounts uplink air-time for both the first service provider and the second service provider based on reported statistics received from the first and second clients.

15. An access point of a wireless network, comprising:
a controller for calculating a first portion of a first uplink air-time for a first client of a first service provider and a second portion of a second uplink air-time for a second client of a second service provider;
a transceiver port for emitting a first control signal to limit the first client of the first service provider to a first portion of first uplink air-time and a second control signal to limit the second client of the second service provider to a second portion of second uplink air-time; and
a connection port for linking the first and second service providers to a backhaul.

16. The access point of a wireless network according to claim 15, wherein a first client of the first service provider and other clients of the first service provider all receive a same first control signal and each have a same first portion of first uplink air-time.

17. The access point of a wireless network according to claim 15, wherein the controller maintains the first uplink air-time to the first service provider that is a difference of total airtime quota for the first service provider and downlink air-time allocated to the first service provider.

18. The access point of a wireless network according to claim 15, wherein the first client of the first service provider and other clients of the first service provider each have a same first portion of first uplink air-time.

19. The access point of a wireless network according to claim 15, wherein the second client of the second service provider has a second portion of second uplink air-time larger than a third portion of second uplink air-time for other clients of the second service provider.

20. The access point of a wireless network according to claim 15, wherein the controller accounts uplink air-time for both the first service provider and the second service provider based on reported statistics received from the first and second groups of clients.
